(19) United States
(12) Patent Application Publication
(10) Pub. No.: US 2021/0044386 A1
(43) Pub. Date: Feb. 11, 2021

(54) RETRY MECHANISM ARCHITECTURE

(71) Applicant: T-Mobile USA, Inc., Bellevue, WA (US)

(72) Inventor: Mayank Kaul, Renton, WA (US)

(21) Appl. No.: 16/536,464

(22) Filed: Aug. 9, 2019

(51) Int. Cl. H04L 1/18; H04L 29/06

(52) U.S. Cl. CPC H04L 1/188; H04L 69/22

(57) ABSTRACT

A network, particularly a wireless network, retries sending packets that fail to be acknowledged by a recipient. Rather than using standard timeouts specified by relevant standards, a retry mechanism is programmed for each packet entering a node based on at least characteristics of the packet. One or more characteristics of the retry mechanism may be set including, but not limited to, a delay time to wait before resending and a number of retries to attempt. The packet characteristics evaluated for setting the retry mechanism may include an access network used for introducing the packet into the network, such as WiFi or 4G/5G, an IP address, or a device type. Other conditions such as network congestion may be considered when programming the retry mechanism for a particular packet.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Various networks set standard timeout conditions for networks. For example, the organization that manages 4G wireless protocols defines various timers used in those networks. T1, the round trip time estimate is set to 500 ms. Timer B and Timer F, the INVITE and non-INVITE transaction timers, respectively, are set to 64*T1, or 32 seconds. T4, a maximum duration for a message, is set to 5 seconds. However, these standards-based times may not be appropriate for all messages. To illustrate, WiFi messages originated on an airplane may require more time to propagate through a network than packets originated at a 5G cell.

### SUMMARY

In an embodiment, a method of managing network traffic in a communication network examines a packet arriving at a node and determines one or more characteristics of the packet based on indicia in the packet. The packet may include a source and destination Internet Protocol (IP) addresses, the type of device being used, whether the device is accessing the network via WiFi or a cellular carrier network, and even the nature of the packet, such as a 911 call. The node may evaluate the indicia from the packet, and in some cases, external network conditions, and change the settings for the node's retry mechanism for that packet based on those indicia and/or external network conditions. This may allow more time for destinations with higher than average latency and faster retries for high importance communication such as 911 calls. The settings affected may include wait time for a response and/or the number of retries for a given packet.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a system illustration of network communication system in accordance with the current disclosure;

FIG. 2 illustrates a network architecture associated with a particular call type;

FIG. 3 is a block diagram of an exemplary retry mechanism in accordance with the current disclosure;

FIG. 4 is a flowchart of a method of managing network communications in accordance with the current disclosure.

### DETAILED DESCRIPTION

Retry mechanisms are foundational to packet-based network communication systems because packets are from time to time misdirected, corrupted, delayed by network congestion, or simply lost. When a network node sends a packet, the node expects to receive an acknowledgement (ack) that the packet was received by the downstream network node or endpoint. A retry mechanism notes when a packet is sent and if an acknowledgement is not received before a specified timeout period, the packet is resent. The retry mechanism may try to resend the packet a specified number of times before the packet is marked as undelivered. When this occurs, a message may be sent to the network node from which the packet was received. There may be a dozen or more nodes involved in the ultimate delivery of a packet, each with its own retry mechanism and as will be apparent in the following discussion, retry mechanism settings may affect performance of the entire network. However, in prior art embodiments, each retry mechanism is programmed to a standards-compliant value. As mentioned above, several significant values in 3GPP networks are time T1 and timers B and F. Time T1 has a standard value of 500 milliseconds and each of timers B and F are set at 64*T1 for a value of 32 seconds. While a round trip time of ½ second may be excessive in most modern network situations, not to mention a time of 32 seconds, there may be circumstances where these times are not long enough. Among the possible impacts of retry mechanism settings are retries which occur too soon, flooding the network with extraneous packets and the opposite, delays that are too long so that messages may be inappropriately delayed.

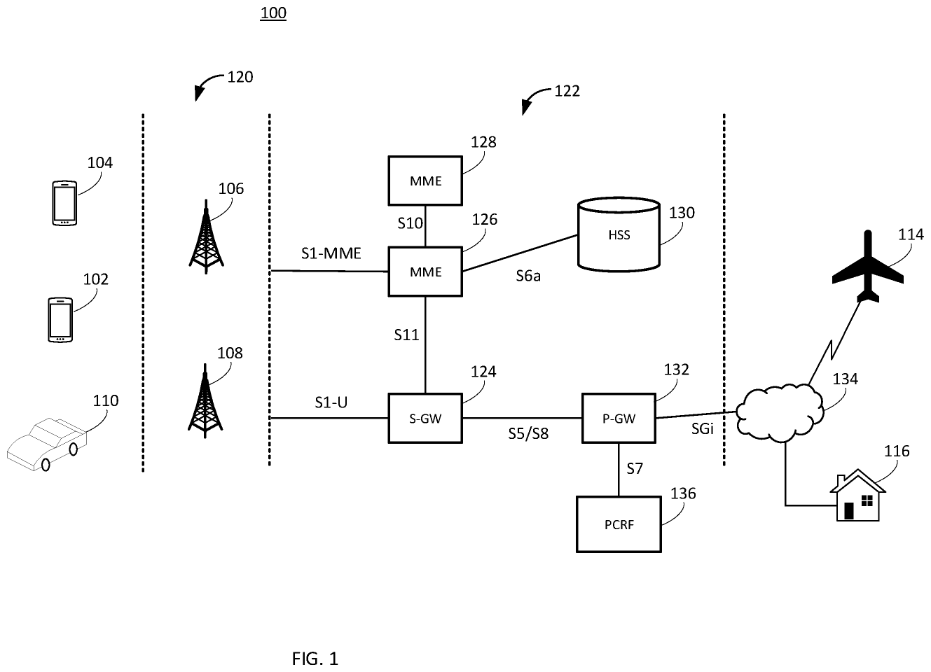

FIG. 1 is an illustration of an exemplary communication system 100 supporting communication between a number of endpoints. A number of devices serviced by an access network 120 (e.g., radio access network or RAN) may include smartphones 102, 104 as well as a connected vehicle 110, among others. Other devices may be serviced by WiFi or wired networks, including, but not limited to devices on airplanes 114 or Internet of Things (IoT) devices found in a home 116. Of course, these are only exemplary as the number and variety of connected devices is virtually unlimited.

The access network 120 may include various cell sites 106, 108, each supporting a cell site of radio frequency coverage, referred to in 4G terminology as an evolved base station (eNodeB or eNB). Each cell site 106, 108 may include one or more antennas, transmitters, receivers, and controller (not depicted). Each cell site can handle a plurality of different subscriber's devices using directional antennas and often different frequencies.

Managing communication between subscriber devices and between a subscriber device and an external data networks (the outside world) 134, is a core network 122, called in the 4G LTE example, the evolved packet core (EPC). The core network 122 illustrated here is greatly simplified for the sake of clarity. A serving gateway 124 may act as a router between cell sites 106, 108 and the rest of traffic-oriented components. Mobility management entities (MMEs) 126, 128 manage signaling to the base stations including call set up and handoffs. A home subscriber server (HSS) 130 may be a central database that contains information about all the subscribers to the operator's communication system 100. A packet data gateway (P-GW) 132 handles communication between subscriber devices 102, 104 and the outside world 134, including devices accessed via WiFi or another carrier, for example, airplane-based cell phones and IoT devices in a home 116.

A policy server 136, known in the 4G example as a policy control and charging rules function (PCRF) is responsible for control decision-making and flow-based charging. In an embodiment, the policy server 136 instructs the P-GW 132 to enforce the PCRF's decisions via a policy control enforcement function (not depicted) which resides in the P-GW 132.

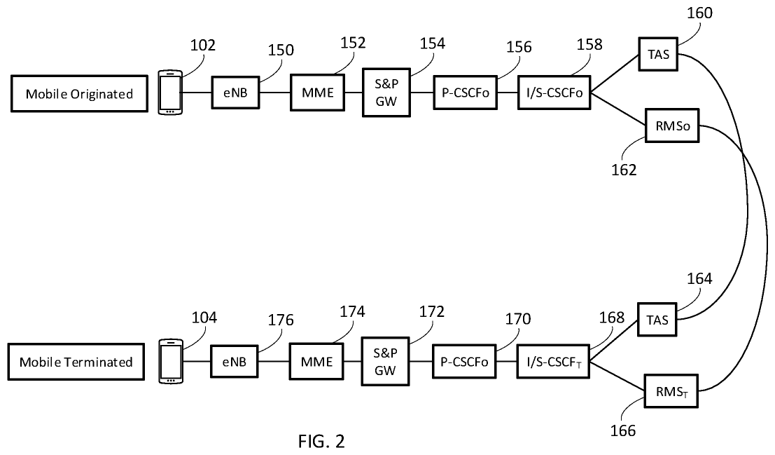

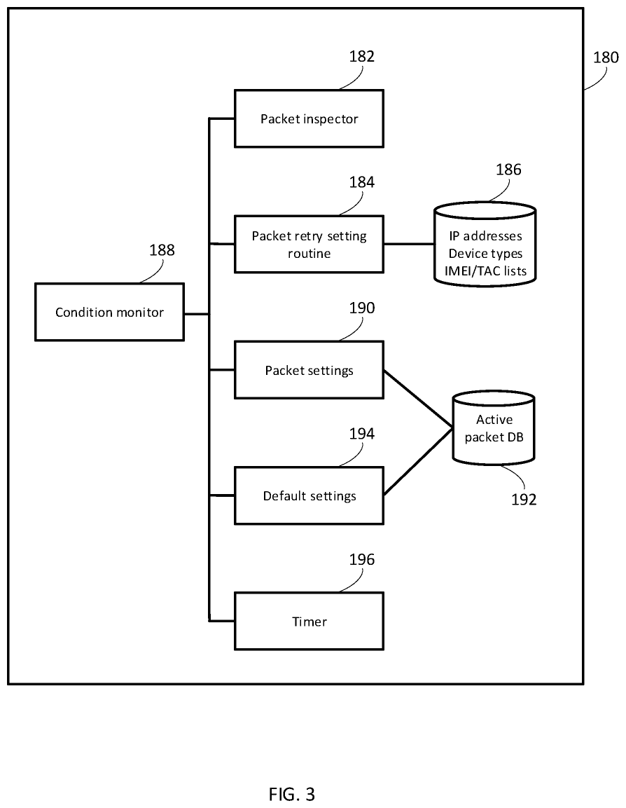

FIG. 2 is a block diagram illustrating in more detail the network nodes involved in an exemplary mobile-to-mobile communication, either voice or data/message. Each node in this illustration, including the originating mobile device 102 may implement a retry mechanism. An exemplary retry mechanism 180 is described below with respect to FIG. 3.

In the illustrated call flow of FIG. 2, an originating mobile device 102 may send voice or message data through an originating chain of nodes beginning with an eNB 150 which forwards the data to an MME 152 which in turn forwards the data to the gateway 154. The data enters what is known as an IP multimedia subsystem (IMS) at the originating proxy call session control function (P-CSCF) 156 and is further processed at the inbound and serving (I/S) CSCF functions 158. If the data is voice, it may be handled by a telephony application server (TAS) 160 while other data may be a Rich Messaging Service (RMS) 162. In current system implementations, this distinction may not be clear cut. A receiving, or terminating data chain may mirror the originating chain and may include a TAS 164 or RMS 166 as well as an I/S-CSCF 168 and P-CSCF 170. The data may leave the terminating IMS and be routed to the terminating user equipment 104 via an S&P gateway 172, MME 174, and eNB 176. The routing and business functions of the above-listed nodes are well known in the art and are not discussed in more detail here, with the focus remaining on selectively assigning retry settings on a packet-by-packet basis based on packet-specific data and/or network-specific condition.

Turning now to FIG. 3, a simplified and exemplary retry mechanism 180 is illustrated. The retry mechanism may be implemented in executable code, for example, in a mobile device, or may be a combination of hardware and software such as in a high speed switch or router. A packet inspector 182 may review data in a packet, including but not limited to, an access type, an IP address of source, destination, or both, or a device type. A packet retry setting routine 184 may take the relevant information identified by the packet inspector 182 and consult a database 186. The database 186 may include retry setting information for the packet based using one or more of the extracted packet data as an index. In an embodiment, the database 186 may be kept local to the particular network node or may be located remotely from the actual node. The setting routing 184 may also, in some embodiments, consult a condition monitor 188 that reports local network conditions, such as congestion or expected round trip times. A packet settings module 190 may store the actual settings for a particular packet while an active packet database 192 may store information about packets being processed. The information may include when a packet was sent and a current number of retries, among other information. When an incoming packet does not match any special criteria, default settings 194, such as standards-based recommendations may be used. A timer 196 or simply a clock may be used to determine when a packet response has not been received within the prescribed time so that a retry may be initiated or the packet may be set as expired. Packet retries may have a profound effect on the network in terms of both delays, when nodes wait overly long for an acknowledgement, or, at the other hand, additional network traffic when a node begins to resend packets prematurely, causing duplicate packets to flood the network. Identifying and managing packets that may need special handling can reduce the impact of both of these potential consequences.

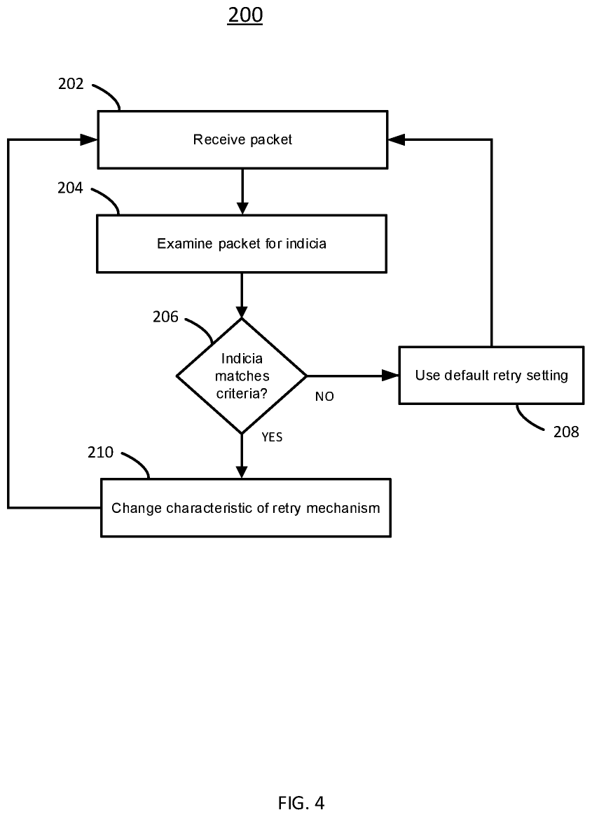

FIG. 4 is a flowchart of a method 200 of managing network traffic in a communication network. The method 200 may apply to any node in the communication network that typically monitors packet delivery and retries packets that are not acknowledged within a given timeout period. At block 202, a packet may be received at a node, for example, P-CSCF 170 of FIG. 2. The packet may be examined for indicia at block 204, the indicia may include source or destination addresses, call type, a device type of the sending device, or a connection type over which the packet was received, such as WiFi or LTE.

A decision at block 206 determines if any of the indicia found in the packet match criteria for updating a setting in a retry mechanism 180 for that packet. For example, packets originating via a wireless connection on an airplane may benefit from longer timeout times so that duplicate packets are not generated for an inherently slow connection. Conversely, 911 call packets may be given a shorter timeout so that every effort is made to ensure a speedy connection. If a match between packet characteristics and the predetermined criteria is found, execution may continue at block 210 and the retry mechanism 180 may be updated to accommodate special handling for that packet. If no match exists, execution may continue at block 208 and the packet may be assigned default values at the retry mechanism 180.

A technical effect of per-packet retry programming is an improvement in packet throughput as well as a corresponding reduction in network traffic due to avoiding unnecessary retries. When packet transit times are more accurately defined, still viable packets are not resent while lost packets may be more quickly identified and recovered.

This technique benefits primarily network operators in lowered operating costs and improved throughput. However, system users may also benefit from those effects in terms of higher effective data rates and lower subscription costs.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of managing network traffic in a communication network, the method comprising:
examining a packet at a network node;
determining from indicia in the packet a characteristic of the packet; and
in response to matching a criterion by the determined indicia, changing a characteristic of a retry mechanism for the packet based on the indicia, wherein changing the characteristics comprises updating a setting in the retry mechanism for the packet.

2. The method of claim 1, wherein the indicia is an access network that originated the packet.

3. The method of claim 2, wherein the access network is a WiFi network.

4. The method of claim 2, wherein the indicia is an Internet Protocol (IP) address and the access network is an aircraft-based network.

5. The method of claim 2, wherein the indicia indicates a device type.

6. The method of claim 5, wherein the indicia is one of an International Mobile Equipment Identity (IMEI) or a type access (TAC) code.

7. The method of claim 1, wherein the indicia is a 911 call indicator.

8. The method of claim 1, wherein changing the characteristic of the retry mechanism comprises updating a timeout timer for the packet.

9. The method of claim 1, wherein changing the characteristic of the retry mechanism comprises updating a retry time for re-sending the packet.

10. The method of claim 1, wherein changing the characteristic of the retry mechanism comprises updating a delay time to wait before re-sending the packet.

11. The method of claim 1, wherein changing the characteristic of the retry mechanism comprises updating a number of retries to attempt re-sending the packet.

12. The method of claim 1, further comprising evaluating a second indicia from the packet wherein changing the characteristic of the retry mechanism for the packet is based on a combination of the indicia and the second indicia.

13. The method of claim 1, further comprising evaluating a network attribute, wherein changing the characteristic of the retry mechanism for the packet is based on the indicia and the network attribute.

14. The method of claim 13, wherein the network attribute is a level of network congestion.

15. A retry mechanism used in a network node in a communication network comprising:
a packet inspection module;
a packet retry setting module coupled to the packet inspection module;
a packet settings module and a default settings module that contain data for use by the packet retry setting module;
a timer used to determine an elapsed time from when a packet was sent; and
wherein the packet retry setting module, in response to matching a criterion by the determined elapsed time, updates a setting in the packet settings module for the packet.

16. The retry mechanism of claim 15, further comprising a condition monitor that supplies data corresponding to system conditions to the packet retry settings module.

17. A method of managing network traffic in a communication network, the network comprising:
receiving a packet at a network node;
determining from indicia in the packet a characteristic of the packet, wherein the characteristic is one of a device type, a call type, an access network and an Internet Protocol (IP) address; and
in response to matching a criterion by the determined indicia, changing a characteristic of a retry mechanism for the packet based on the indicia, wherein changing the characteristics comprises updating a setting in the retry mechanism for the packet.

18. The method of claim 17, further comprising:
evaluating a network characteristic at a time of receiving the packet, wherein changing the characteristic of the retry mechanism comprises changing updating the characteristic of the retry mechanism based on a combination of the indicia and the network characteristic.

19. The method of claim 18, wherein the network characteristic is a network congestion level.

20. The method of claim 17, wherein changing the characteristic of the retry mechanism comprises one of setting a delay time before resending the packet and setting a number of retries for the packet.
